(19) United States
(12) Patent Application Publication
(10) Pub. No.: US 2018/0007151 A1
(43) Pub. Date: Jan. 4, 2018

(54) Method And Apparatus For Scheduling Broadcasts In Social Networks

(71) Applicant: KING ABDULLAH UNIVERSITY OF SCIENCE AND TECHNOLOGY, Thuwal (SA)

(72) Inventors: Emaad Ahmed Manzoor, Thuwal (SA); Panos Kalnis, Thuwal (SA)

(21) Appl. No.: 15/537,135

(22) PCT Filed: Feb. 19, 2016
(86) PCT No.: PCT/IB2016/050910

§ 371 Date: Jun. 16, 2017

Related U.S. Application Data
(60) Provisional application No. 62/118,570, filed on Feb. 20, 2015.

(51) Int. Cl. H04L 29/08; H04L 12/18; G06N 7/00; G06Q 50/00; H04L 29/06; H04L 12/58

(52) U.S. Cl. CPC H04L 67/22; H04L 65/4076; H04L 51/32; G06N 7/005; G06Q 50/01; H04L 12/1881

(57) ABSTRACT

A method, apparatus, and computer readable medium are provided for maximizing consumption of broadcasts by a producer. An example method includes receiving selection of a total number of time slots to use for scheduling broadcasts, and receiving information regarding the producer's followers. The example method further 5 includes identifying, by a processor and based on the received information, discount factors associated with the producer's followers, and calculating, by the processor and based on the received information, a predicted number of competitor broadcasts during each time slot of the total number of time slots. Finally, the example method includes determining, by the processor and based on the discount factors and the predicted 10 number of competitor broadcasts during each time slot, a number of broadcasts for the producer to transmit in each time slot of the total number of time slots.

### TECHNOLOGICAL FIELD

Example embodiments of the present invention relate generally to social networking and, more particularly, to a method and apparatus for maximizing consumption of a user's broadcasts on a social networking service.

### BACKGROUND

Social networking services are relatively recent innovations, emerging initially in the 1990s and but not having reached wide adoption until the 2000s. While social networking services have evolved in many directions over this period, the most ubiquitous social networking services have developed large user bases in large part as a function of their ability to effectively distribute content among their users. In this regard, using a timeline to view broadcasts by content producers has become a popular design pattern for information dissemination and consumption in online social networking services today. Prominent social networking services providing timelines include Facebook, Twitter, and Instagram. Functionally, the timelines provided by these social networking services can display reverse-chronologically ordered content (e.g., broadcasts from other users), and users can scroll linearly from top to bottom to consume the content.

However, with the large volume of information shared on social media, users frequently exhibit information overload, consuming their timelines only partially from the top downwards. Users also report being irritated seeing their timelines flooded by a single user's posts, resulting in decreased attention towards that user. Content producers thus compete in an attention economy with the goal of maximizing the spread of their posts through the network (e.g., their organic reach).

### BRIEF SUMMARY

If one is a blogger, upcoming creative artiste, or a business trying to gain market share in the attention economy, a lot can be gained by careful scheduling posts tailored to one's followers. Even average users expect their posts to be viewed, liked, favorited and retweeted; this solution would benefit them too. Each user (e.g., producer) who has content she would like to share with her followers (users that receive the producer's broadcasts) is faced with competing considerations regarding how best to broadcast her content.

Social media users login periodically, usually depending on their times at work. Using, for example, on social networking service Twitter™, users react to broadcasts (e.g., tweets) by either retweeting them, which forwards the tweet to all their followers; by starring them, which just marks a tweet with a star; or by replying to a tweet, which initiates a conversation with a tweet producer. As noted above, users consume their timeline from the top downwards; however, they have been shown to only partially consume their timelines, often logging out before reading tweets that are too low on the timeline.

Hence, it is important for the producer to time and place her tweets at or near the top of all her followers' timelines. For a single user, this can be done by tweeting right before the user logs in to Twitter. However, because tweets are broadcasts, if one has many followers, each with a different login time, one has to find a time to tweet that strikes a balance between the competing schedules of all of one's followers.

One way to solve this is to flood, by tweeting once every second, for example. This way, all of one's followers' timelines will almost completely be filled with one's own tweets. The problem with this tactic is that it leads to irritation, and users have been shown to either ignore such floods of tweets, or unfollow the offending user. These facts reveal two problems to be solved: when to tweet, and how much to tweet.

Embodiments described herein provide a mechanism addressing both of these problems, and thus enhancing the consumption of a producer's tweets. As illustrated below, example embodiments enable both an identification of a time slot during which to transmit content, and an identification of a number of broadcasts to transmit during that time slot. While these embodiments are discussed herein in the context of the social networking service Twitter™, it should be understood that embodiments described herein are applicable to any social networking service that provides a reverse-chronologically ordered timeline of broadcasts.

In a first example embodiment, a method is provided for maximizing consumption of broadcasts by a producer. The method includes receiving selection of a total number of time slots to use for scheduling broadcasts, and receiving information regarding the producer's followers. The method further includes identifying, by a processor and based on the received information, discount factors associated with the producer's followers, and calculating, by the processor and based on the received information, a predicted number of competitor broadcasts during each time slot of the total number of time slots. Yet further, the method includes determining, by the processor and based on the discount factors and the predicted number of competitor broadcasts during each time slot, a number of broadcasts for the producer to transmit in each time slot of the total number of time slots. The method may further include causing transmission of the determined number of broadcasts in each time slot of the total number of time slots.

In some embodiments, the information regarding the producer's followers includes: information regarding a set of producers followed by each of the producer's followers; information regarding broadcasts transmitted by each of the producer's followers; and information regarding timelines of each of the producer's followers.

In some embodiments, the discount factors associated with the producer's followers include login times of each of the producer's followers, a degree of information overload of each of the producer's followers, and a degree of monotony aversion of each of the producer's followers.

In such embodiments, identifying the login times of the producer's followers may include, for each particular follower of the producer's followers, identifying, based on the received information regarding the producer's followers, a first subset of the time slots during which the particular follower transmitted a broadcast, and identifying, based on the received information regarding the producer's followers, a second subset of time slots during which a predetermined period of time had not elapsed after the particular follower transmitted a broadcast. Consequently, the login times of the particular follower may comprise a union of the first subset of time slots and the second subset of time slots.

In other such embodiments, identifying the degrees of information overload of the producer's followers may include, for each particular follower of the producer's followers, identifying, based on the received information regarding the producer's followers, a depth of each broadcast on the timeline of the particular follower that was re-transmitted by the particular follower, and identifying a total number of broadcasts on the timeline of the particular follower at each identified depth. Subsequently, the method may include calculating a probability that the particular follower will re-transmit a broadcast located at each of the identified depths, and determining an average ratio of a decrease in probability of re-transmission per unit increase in depth on the timeline of the particular follower. Consequently, the degree of information overload of the particular follower may comprise the determined average ratio.

In yet other such embodiments, identifying the degrees of monotony aversion of the producer's followers may include, for each particular follower of the producer's followers, identifying, based on the received information regarding the producer's followers, a cluster size associated with each broadcast on the timeline of the particular follower that was re-transmitted by the particular follower, and identifying a total number of broadcasts on the timeline of the particular follower associated with the identified cluster sizes. Furthermore, these embodiments include calculating a probability that the particular follower will re-transmit a broadcast associated with each of the identified cluster sizes, and determining an average ratio of the decrease in probability of re-transmissions per unit increase in cluster size associated with a broadcast on the timeline of the particular follower. Consequently, the degree of monotony of the particular follower may comprise the determined average ratio.

In some embodiments calculating the predicted number of broadcasts by competitors in each time slot of the total number of time slots may include identifying, based on the received information regarding the producer's followers, a set of competitors, and calculating a historical average number of broadcasts transmitted by the set of competitors in each time slot of the total number of time slots, wherein the predicted number of broadcasts by competitors in each time slot of the total number of time slots comprises the historical average number of broadcasts transmitted by the set of competitors in each time slot of the total number of time slots.

In some embodiments, determining the number of broadcasts for the producer to transmit in each time slot may include generating an objective scoring function based on the discount factors and the number of competitor broadcasts in each time slot, and identifying a number of broadcasts in each time slot of the total number of time slots that maximizes the objective scoring function. In such embodiments, identifying the number of broadcasts in each time slot of the total number of time slots that maximizes the objective scoring function may include generating a relaxed scoring function by ignoring an impact of one of the discount factors, identifying a number of broadcasts in each time slot of the total number of time slots that maximizes the relaxed scoring function, and applying, based on the number of broadcasts in each time slot of the total number of time slots that maximizes the relaxed scoring function, a greedy algorithm to identify the number of broadcasts in each time slot of the total number of time slots that maximizes the objective scoring function.

In another example embodiment, an apparatus is provided for maximizing consumption of broadcasts by a producer. The apparatus includes a processor and a memory storing program code instructions that, when executed by the processor, cause the apparatus to receive selection of a total number of time slots to use for scheduling broadcasts, and receive information regarding the producer's followers; The program code instructions, when executed by the processor, further cause the apparatus to identify, based on the received information, discount factors associated with the producer's followers, calculate, based on the received information, a predicted number of competitor broadcasts during each time slot of the total number of time slots, and determine, based on the discount factors and the predicted number of competitor broadcasts during each time slot, a number of broadcasts for the producer to transmit in each time slot of the total number of time slots. The program code instructions, when executed by the processor, may further cause the apparatus to cause transmission of the determined number of broadcasts in each time slot of the total number of time slots.

In some embodiments, the information regarding the producer's followers includes: information regarding a set of producers followed by each of the producer's followers; information regarding broadcasts transmitted by each of the producer's followers; and information regarding timelines of each of the producer's followers.

In some embodiments, the discount factors associated with the producer's followers include login times of each of the producer's followers, a degree of information overload of each of the producer's followers, and a degree of monotony aversion of each of the producer's followers.

In some such embodiments, the program code instructions, when executed by the processor, cause the apparatus to identify the login times of the producer's followers by causing the apparatus to, for each particular follower of the producer's followers, identify, based on the received information regarding the producer's followers, a first subset of the time slots during which the particular follower transmitted a broadcast, and identify, based on the received information regarding the producer's followers, a second subset of time slots during which a predetermined period of time had not elapsed after the particular follower transmitted a broadcast, wherein the login times of the particular follower comprises a union of the first subset of time slots and the second subset of time slots.

In other such embodiments, the program code instructions, when executed by the processor, cause the apparatus to identify the degrees of information overload of the producer's followers by causing the apparatus to, for each particular follower of the producer's followers, identify, based on the received information regarding the producer's followers, a depth of each broadcast on the timeline of the particular follower that was re-transmitted by the particular follower, identify a total number of broadcasts on the timeline of the particular follower at each identified depth, calculate a probability that the particular follower will re-transmit a broadcast located at each of the identified depths, and determine an average ratio of a decrease in probability of re-transmission per unit increase in depth on the timeline of the particular follower, wherein the degree of information overload of the particular follower comprises the determined average ratio.

In yet other such embodiments, the program code instructions, when executed by the processor, cause the apparatus to identify the degrees of monotony aversion of the producer's followers by causing the apparatus to, for each particular follower of the producer's followers, identify, based on the received information regarding the producer's followers, a cluster size associated with each broadcast on the timeline of the particular follower that was re-transmitted by the particular follower, identify a total number of broadcasts on the timeline of the particular follower associated with the identified cluster sizes, calculate a probability that the particular follower will re-transmit a broadcast associated with each of the identified cluster sizes; and determine an average ratio of the decrease in probability of re-transmissions per unit increase in cluster size associated with a broadcast on the timeline of the particular follower, wherein the degree of monotony of the particular follower comprises the determined average ratio.

In some embodiments, the program code instructions, when executed by the processor, cause the apparatus to calculate the predicted number of broadcasts by competitors in each time slot of the total number of time slots by causing the apparatus to identify, based on the received information regarding the producer's followers, a set of competitors, and calculate a historical average number of broadcasts transmitted by the set of competitors in each time slot of the total number of time slots, wherein the predicted number of broadcasts by competitors in each time slot of the total number of time slots comprises the historical average number of broadcasts transmitted by the set of competitors in each time slot of the total number of time slots.

In some embodiments, the program code instructions, when executed by the processor, cause the apparatus to determine the number of broadcasts for the producer to transmit in each time slot by causing the apparatus to generate an objective scoring function based on the discount factors and the number of competitor broadcasts in each time slot, and identify a number of broadcasts in each time slot of the total number of time slots that maximizes the objective scoring function. In some such embodiments, the program code instructions, when executed by the processor, cause the apparatus to identify the number of broadcasts in each time slot of the total number of time slots that maximizes the objective scoring function by causing the apparatus to generate a relaxed scoring function by ignoring an impact of one of the discount factors, identify a number of broadcasts in each time slot of the total number of time slots that maximizes the relaxed scoring function, and apply, based on the number of broadcasts in each time slot of the total number of time slots that maximizes the relaxed scoring function, a greedy algorithm to identify the number of broadcasts in each time slot of the total number of time slots that maximizes the objective scoring function.

In yet another example embodiment, a non-transitory computer readable storage medium storing is provided for maximizing consumption of broadcasts by a producer. The non-transitory computer readable storage medium stores program code instructions that, when executed by an apparatus, cause the apparatus to receive selection of a total number of time slots to use for scheduling broadcasts, and receive information regarding the producer's followers; The program code instructions, when executed, further cause the apparatus to identify, based on the received information, discount factors associated with the producer's followers, calculate, based on the received information, a predicted number of competitor broadcasts during each time slot of the total number of time slots, and determine, based on the discount factors and the predicted number of competitor broadcasts during each time slot, a number of broadcasts for the producer to transmit in each time slot of the total number of time slots. The program code instructions, when executed, may further cause the apparatus to cause transmission of the determined number of broadcasts in each time slot of the total number of time slots.

In some embodiments, the information regarding the producer's followers includes: information regarding a set of producers followed by each of the producer's followers; information regarding broadcasts transmitted by each of the producer's followers; and information regarding timelines of each of the producer's followers.

In some embodiments, the discount factors associated with the producer's followers include login times of each of the producer's followers, a degree of information overload of each of the producer's followers, and a degree of monotony aversion of each of the producer's followers.

In some such embodiments, the program code instructions, when executed, cause the apparatus to identify the login times of the producer's followers by causing the apparatus to, for each particular follower of the producer's followers, identify, based on the received information regarding the producer's followers, a first subset of the time slots during which the particular follower transmitted a broadcast, and identify, based on the received information regarding the producer's followers, a second subset of time slots during which a predetermined period of time had not elapsed after the particular follower transmitted a broadcast, wherein the login times of the particular follower comprises a union of the first subset of time slots and the second subset of time slots.

In other such embodiments, the program code instructions, when executed, cause the apparatus to identify the degrees of information overload of the producer's followers by causing the apparatus to, for each particular follower of the producer's followers, identify, based on the received information regarding the producer's followers, a depth of each broadcast on the timeline of the particular follower that was re-transmitted by the particular follower, identify a total number of broadcasts on the timeline of the particular follower at each identified depth, calculate a probability that the particular follower will re-transmit a broadcast located at each of the identified depths, and determine an average ratio of a decrease in probability of re-transmission per unit increase in depth on the timeline of the particular follower, wherein the degree of information overload of the particular follower comprises the determined average ratio.

In yet other such embodiments, the program code instructions, when executed, cause the apparatus to identify the degrees of monotony aversion of the producer's followers by causing the apparatus to, for each particular follower of the producer's followers, identify, based on the received information regarding the producer's followers, a cluster size associated with each broadcast on the timeline of the particular follower that was re-transmitted by the particular follower, identify a total number of broadcasts on the timeline of the particular follower associated with the identified cluster sizes, calculate a probability that the particular follower will re-transmit a broadcast associated with each of the identified cluster sizes; and determine an average ratio of the decrease in probability of re-transmissions per unit increase in cluster size associated with a broadcast on the timeline of the particular follower, wherein the degree of monotony of the particular follower comprises the determined average ratio.

In some embodiments, the program code instructions, when executed, cause the apparatus to calculate the predicted number of broadcasts by competitors in each time slot of the total number of time slots by causing the apparatus to identify, based on the received information regarding the producer's followers, a set of competitors, and calculate a historical average number of broadcasts transmitted by the set of competitors in each time slot of the total number of time slots, wherein the predicted number of broadcasts by competitors in each time slot of the total number of time slots comprises the historical average number of broadcasts transmitted by the set of competitors in each time slot of the total number of time slots.

In some embodiments, the program code instructions, when executed, cause the apparatus to determine the number of broadcasts for the producer to transmit in each time slot by causing the apparatus to generate an objective scoring function based on the discount factors and the number of competitor broadcasts in each time slot, and identify a number of broadcasts in each time slot of the total number of time slots that maximizes the objective scoring function. In some such embodiments, the program code instructions, when executed, cause the apparatus to identify the number of broadcasts in each time slot of the total number of time slots that maximizes the objective scoring function by causing the apparatus to generate a relaxed scoring function by ignoring an impact of one of the discount factors, identify a number of broadcasts in each time slot of the total number of time slots that maximizes the relaxed scoring function, and apply, based on the number of broadcasts in each time slot of the total number of time slots that maximizes the relaxed scoring function, a greedy algorithm to identify the number of broadcasts in each time slot of the total number of time slots that maximizes the objective scoring function.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is a block diagram of an example computing device that may comprise or be utilized by example embodiments of the present invention;

FIG. 2 illustrates various types of social networking service timeline activity, in accordance with some example embodiments of the present invention;

FIG. 3 illustrates graphical depictions of bursty circadian rhythms (e.g., login times), information overload, and monotony aversion information associated with a user of a social networking service, in accordance with some example embodiments of the present invention;

FIG. 4 illustrates theories of user reaction to broadcast clusters, in accordance with some example embodiments of the present invention;

FIG. 5 shows a graph illustrating probabilities that a user will re-transmit a broadcast under varying conditions, in accordance with some example embodiments of the present invention;

FIGS. 6A and 6B illustrate activity indicators associated with users of a social networking service, in accordance with some example embodiments of the present invention;

FIGS. 7A and 7B illustrate distributions of inter-event time between consecutive broadcasts, in accordance with some example embodiments of the present invention;

FIG. 8 illustrates a diagram providing timeline construction, consumption, and nomenclature information, in accordance with some example embodiments of the present invention;

FIG. 9 illustrates a flow chart including example operations performed by a computing device to maximize consumption of a producer's broadcasts on a social networking service, in accordance with some example embodiments of the present invention;

FIG. 10 illustrates a flow chart including example operations performed by a computing device to identify discount factors associated with a producer's followers, in accordance with some example embodiments of the present invention;

FIG. 11 illustrates a flow chart including example operations performed by a computing device to identify login times of a producer's followers, in accordance with some example embodiments of the present invention;

FIG. 12 illustrates a flow chart including example operations performed by a computing device to identify degrees of information overload of a producer's followers, in accordance with some example embodiments of the present invention;

FIG. 13 illustrates a flow chart including example operations performed by a computing device to identify degrees of monotony aversion of a producer's followers, in accordance with some example embodiments of the present invention;

FIG. 14 illustrates a flow chart including example operations performed by a computing device to calculate a predicted number of competitor broadcasts during each time slot, in accordance with some example embodiments of the present invention;

FIG. 15 illustrates a flow chart including example operations performed by a computing device to determine a number of broadcasts for a producer to transmit in each time slot, in accordance with some example embodiments of the present invention; and

FIG. 16 illustrates a flow chart including example operations performed by a computing device to identify a number of broadcasts in each time slot that maximizes an objective scoring function, in accordance with some example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Overview

Example embodiments of the present invention are able to maximize consumption of the user's content by identifying time slots during which to transmit content and determining how frequently to transmit broadcasts during each identified time slot. As mentioned previously, while embodiments described herein are discussed in the context of the a user distributing content using the social networking service Twitter™, it should be understood that such discussion is for ease of description only, and these and other embodiments are applicable to any social networking service that provides a reverse-chronologically ordered timeline of broadcasts. For instance, embodiments described herein can maximize content viewership on other social networking services, such as those provided by Facebook, Instagram, Yahoo!, Google, and Buffer. Regardless of which social networking service is utilized, though, the procedure performed by an example embodiment can be divided into two phases: the estimation phase and the action phase.

Before the estimation phase, though, the first step is to identify a number of time slots S to use for scheduling broadcasts. For example, setting S=24, results in a determination of how many tweets to send every hour. Of course, a larger S value provides finer timing granularity, and a smaller S provides less granularity but may be more practical for many users. After selection of a number of time slots S, the procedure enters the estimation phase, during which each of the producer's followers can be analyzed to calculate the following parameters: the follower's login time, the follower's degree of information overload, and the follower's degree of monotony aversion.

The follower's login time (the first parameter) is estimated by observing the times the user tends to be active on the social networking service. This information is easily obtainable by collecting the follower's own tweets. The login time can be bounded by the time after a specified gap where no tweets have been sent (e.g., 15-30 minutes).

The degree of information overload (the second parameter) captures how far down on the follower's timeline the follower actually reads. This can be estimated by identifying, for each login time, the depth of each tweet on the user's timeline that the follower retweeted, and then calculating the probability of retweeting for a given depth. This probability decreases with depth, and the ratio of decrease produces the degree of information overload for that follower.

The degree of monotony aversion (the third parameter) captures how much the probability of retweeting a specific producer's tweet decreases with the number of tweets by the same producer around it. For example, one may expect a 50% chance of being retweeted when posting a single tweet. However, if one posts 2 tweets in a few seconds, such that they appear one after the other on a follower's timeline, the retweet chances of each drop to 25%. The ratio of decrease estimated from the follower's own broadcast data thus provides this parameter.

Once these parameters are collected for each follower, other users that this follower follows are evaluated: these other users are called competitors with respect to this follower (note that the competitors may be different for different followers). This evaluation includes calculating, on average, how many tweets by all the competitors are posted in each time slot.

In the action phase of example embodiments, the above parameters are provided to the scoring function described below. Solving the optimization problem provides the number of posts to produce in each time slot that would maximize the attention the producer can expect to receive.

### Computing Platform

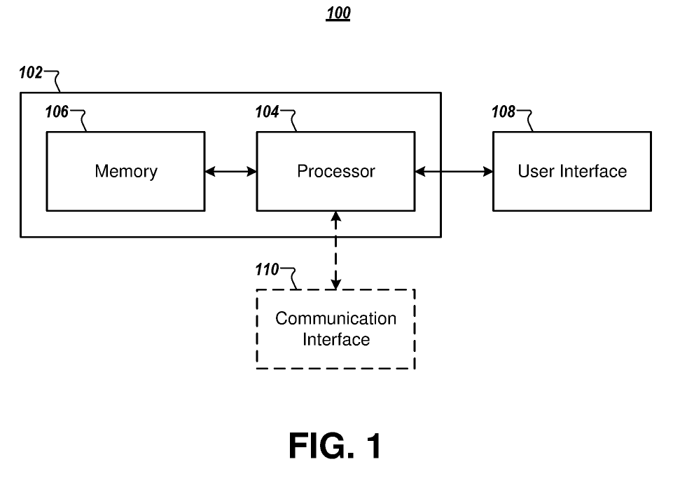

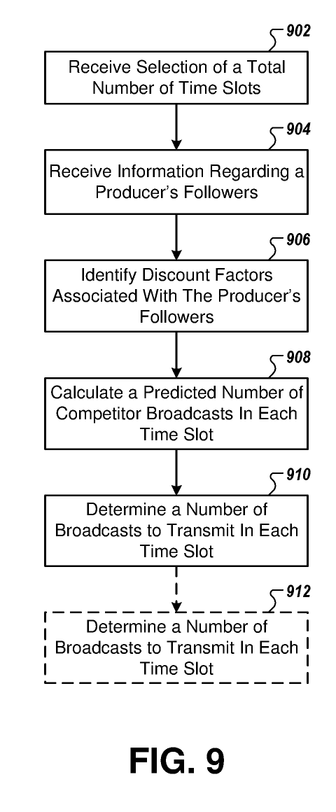

FIG. 1 shows a computing device 100 that may perform the operations described herein for identifying a time slot during which to transmit content, and identifying a number of broadcasts to transmit during that time slot in order. It is contemplated that the computing device 100 may be configured to perform various operations in accordance with example embodiments of the present invention, such as in conjunction with the operations described in conjunction with FIGS. 9 through 16 below. It should be noted that the components, devices, and elements described herein may not be mandatory in every embodiment of the computing device 100, and some may be omitted in certain embodiments. Additionally, some embodiments may include further or different components, devices or elements beyond those shown and described herein.

As shown in FIG. 1, the computing device 100 may include or otherwise be in communication with a processing system including, for example, processing circuitry 102 that is configurable to perform actions in accordance with example embodiments described herein. The processing circuitry 102 may be configured to perform data processing, application execution and/or other processing and management services according to an example embodiment of the present invention. In some embodiments, the computing device 100 or the processing circuitry 102 may be embodied as a chip or chip set. In other words, the computing device 100 or the processing circuitry 102 may comprise one or more physical packages (e.g., chips) including materials, components and/or wires on a structural assembly (e.g., a baseboard). The computing device 100 or the processing circuitry 102 may, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 102 may include a processor 104 and memory 106 that may be in communication with or otherwise control a user interface 108 and, in some embodiments, a communication interface 110. As such, the processing circuitry 102 may be embodied as a circuit chip (e.g., an integrated circuit chip) configured (e.g., with hardware or a combination of hardware and software) to perform operations described herein.

The processor 104 may be embodied in a number of different ways. For example, the processor 104 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 104 may be configured to execute program code instructions stored in the memory 106 or otherwise accessible to the processor 104. As such, whether configured by hardware or by a combination of hardware and software, the processor 104 may represent an entity (e.g., physically embodied in circuitry) capable of performing operations according to embodiments of the present invention while configured accordingly. Thus, for example, when the processor 104 is embodied as an ASIC, FPGA or the like, the processor may include specifically configured hardware for conducting the operations described herein. Alternatively, as another example, when the processor 104 is embodied as an executor of software instructions, the instructions may specifically configure the processor 104 to perform the operations described herein.

The memory 106 may include one or more non-transitory memory devices such as, for example, volatile and/or non-volatile memory that may be either fixed or removable. The memory 106 may be configured to store information, data, applications, instructions or the like for enabling the computing device 100 to carry out various functions in accordance with example embodiments of the present invention. For example, the memory 106 could be configured to buffer input data for processing by the processor 104. Additionally or alternatively, the memory 106 could be configured to store instructions for execution by the processor 104. As yet another alternative, the memory 106 may include one of a plurality of databases that may store a variety of files, contents or data sets. Among the contents of the memory 106, applications may be stored for execution by the processor 104 in order to carry out the functionality associated with each respective application. In some cases, the memory 106 may be in communication with the processor 104 via a bus for passing information among components of the computing device 100.

The user interface 108 may be in communication with the processing circuitry 102 and may receive an indication of user input and/or provide an audible, visual, mechanical or other output to the user. As such, the user interface 108 may include, for example, a keyboard, a mouse, a joystick, a display, a touch screen, a microphone, a speaker, or any other input/output mechanisms.

The communication interface 110 (if implemented) may include one or more interface mechanisms for enabling communication with other devices and/or a network. In some cases, the communication interface may be any means such as a device or circuitry embodied in either hardware, or a combination of hardware and software that is configured to receive and/or transmit data from/to any other device or module in communication with the processing circuitry 102, such as between the computing device 100 and one or more other computing devices connected via a wired or a wireless pathway, such as a local area network (e.g., an organizational intranet), or a wide area network (e.g., the Internet). In this regard, the communication interface may include, for example, an antenna (or multiple antennas) and may support hardware and/or software for enabling communications with a wireless communication network and/or a communication modem or other hardware/software for supporting communication via cable, digital subscriber line (DSL), universal serial bus (USB), Ethernet or other methods. The computing device 100 need not always include a communication interface 110. For example, in instances in which the computing device 100 does not retrieve information regarding a producer's followers from a remote source or broadcast content to the social networking service, a communication interface 110 may not be necessary. As such, the communication interface 110 is shown in dashed lines in FIG. 1.

### Example Techniques for Maximizing Consumption of a Producer's Content

Having provided a high-level overview describing the procedures performed by example embodiments and having described an example computing device 100 that may be configured for use in conjunction with example embodiments, the following description explains in greater detail how example embodiments of the present invention maximize consumption of a producer's content.

Users exhibit bursty social network activity, regulated by their workdays and sleep-cycles (collectively called circadian rhythms). Hence, content producers must strategically schedule posts to appear near the top of each user's timeline at their active times. The restriction to broadcasts constrains producers to a single schedule that must strike a balance between different users' times of activity, degrees of information overload and tolerances to irritation.

Broadcasts are the predominant type of message transmission in online social networks, as opposed to unicast-dominated email and instant messaging. A typical social network user composes and views posts, propagates posts by resharing, and reacts to posts via likes or favorites. These actions are instantly broadcast to all the user's friends or followers, and appear as a sequence of posts on their timelines.

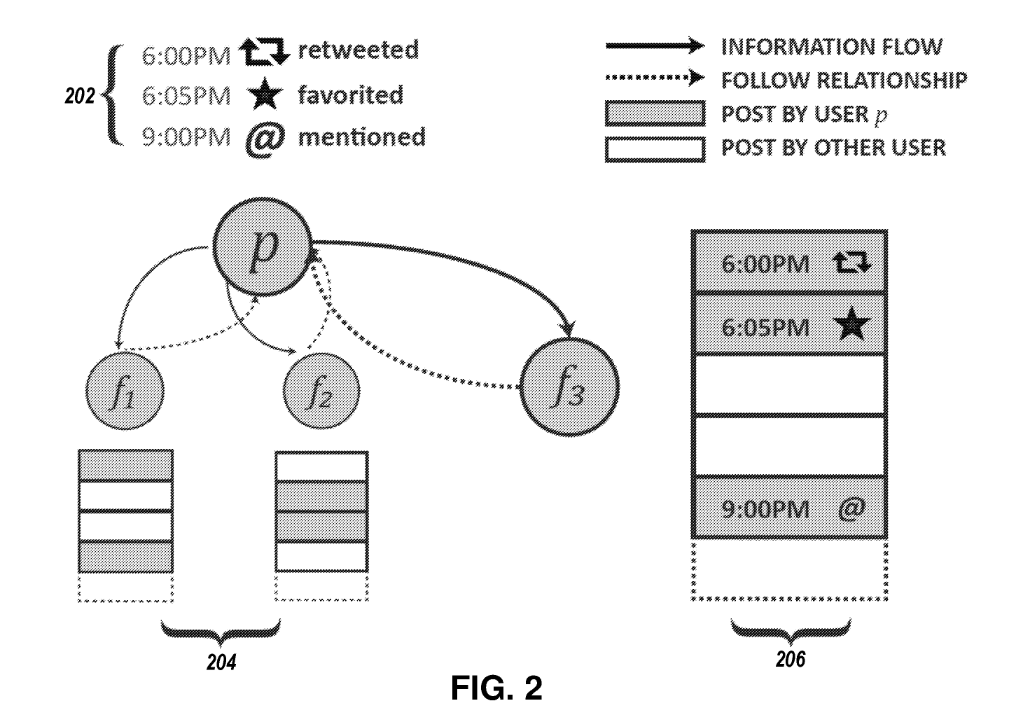

Timelines may be presented in reverse-chronological order, as in Twitter, or by a mixture of recency and social metrics, like the Top Stories timeline in Facebook. It is important to note that a timeline is each user's primary means of engagement with the social network, viewed by the user on every visit to the social network website, and is constantly updated with new content from the user's friends. FIG. 2 illustrates broadcasts-driven communication with timelines on Twitter.

As shown in FIG. 2, user p performs actions 202, which are broadcast and appear on the timelines of her followers f1, f2 and f3 (204). The broadcasts appear at different positions on these timelines, since each follower of p may follow a different set of people who post at different times. A close-up of f3's timeline (206) shows posts by p in chronological order, along with posts from other users that f3 follows.

Professional users, such as businesses, blogs and celebrities, have adopted online social networks as marketing tools. To capitalize on this, social networking services offer sponsored posts that are artificially placed on users' timelines where they are more likely to be seen and reacted to. Professionals hence seek to maximize their organic reach, which is a measure of the views and reactions that one gets for free, without sponsoring any posts. However, social network users have been observed to exhibit a periodic and bursty usage pattern, influenced by daily routine and the human sleep-cycle (collectively known as circadian rhythms). They have also been shown to suffer from information overload and consume their timelines only partially from the top downwards, paying lesser attention to content appearing lower. Hence, posts produced must be carefully scheduled to appear near the top of each user's timeline. Since communication is constrained to broadcasts, a good schedule must strike a balance between the varied levels of overload and different periods of activity exhibited by one's followers. However, there has been little formal study seeking algorithms to define and discover an optimal broadcast schedule.

One scheduling strategy could be to flood the network: broadcast very frequently to guarantee visibility. A natural concern then is of followers being irritated on seeing their timelines flooded by the same user; this has been observed to result in lesser attention and memorability of tweets, irritation, lesser chances of being retweeted, and higher chances of being unfollowed. Accordingly, embodiments described herein quantify and predict irritation, and construct a broadcast schedule to maximize the organic reach, given a number of followers with varied levels of information overload, tolerances to irritation and periods of activity.

The inventors have identified three key phenomena giving rise to the scheduling problem: bursty circadian rhythms, information overload and monotony aversion, which we introduce here for the first time. The existence of circadian bursts in social network activity is validated on a large microblog dataset. The inventors have also qualified and validate a formulation of monotony aversion. Monotony aversion recurs in a number of different settings, and this formulation can aid further understanding of human behavior in these scenarios.

After illustrating the validity of the primary assumptions of the model, the broadcast scheduling problem is illustrated. Subsequently, the problem is formulated, and embodiments are described that utilize an objective function to score broadcast schedules, and utilize a greedy algorithm discover an optimal one. The model used in this procedure is generally applicable to any social network involving broadcasts, timelines and competing content producers.

2. Modeling User Behaviour

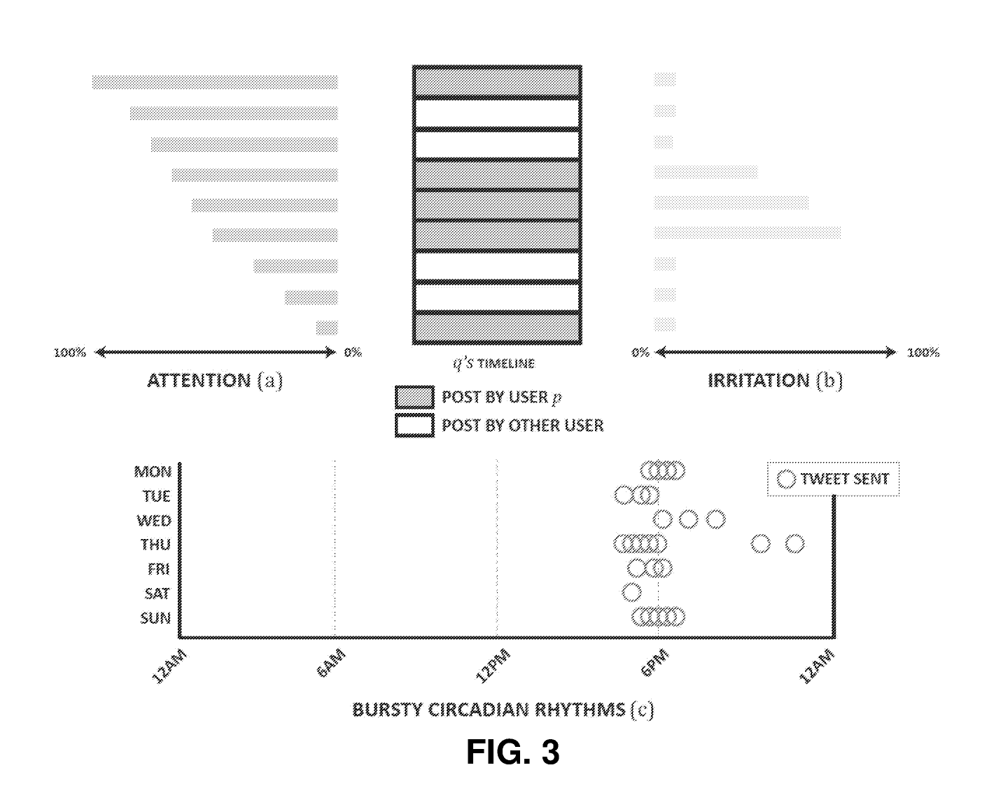

The three behavioral phenomena giving rise to the broadcast scheduling problem (bursty circadian rhythms, monotony aversion and information overload) will be addressed in turn below. These phenomena are illustrated in FIG. 3, which shows the timeline of a user q who follows p, and her variation in attention (a) and irritation (b) as she consumes her timeline. Due to information overload, her attention decreases as she consumes tweets lower down. She is also irritated by closely-spaced clusters of tweets by the same user p. Due to her workday and biological sleep-cycle, her tweeting activity exhibits bursty circadian rhythms (c): she usually tweets at around 6 PM, followed by a long period of inactivity while she is at work or asleep.

Information Overload

Information overload results when the wealth of available information meets humans' limited cognitive processing ability. Research on information overload has generally proceeded in two directions. One studies the hypothesis that a cognitive limit exists on the number of stable relationships that humans can maintain at a time, often referred to as Dunbar's Number. Studies have analyzed this limit empirically and demonstrated how users allocate their time across relationships on Facebook and Twitter. The other focuses on how users allocate attention across different pieces of information; a common setting being content on social network timelines. At the micro-level, surveys and eye-tracking reports show that users pay less attention to information appearing lower on their timelines. In the context of social contagion, research suggests that Twitter users follow the principle of least effort when retweeting, and shows that information overload affects the visibility of content and constrains the spread of contagion. Other research shows that varying attention limits and the network structure are sufficient to explain the large heterogeneity in the spread of different memes on Twitter.

The inventors have validated the following phenomena, which are relevant to embodiments described herein:

1. The policies users use to consume and reshare content are independent from those used to produce original content. Concretely, production and consumption policies are unrelated.

2. Users actively seek out and create new social connections, without placing limits on the number of people they follow. Since each new connection opens an incoming channel of information, users appear to actively seek information overload.

3. There is evidence of information overload: the empirical probability of retweeting a tweet decreases monotonically with the tweet's depth in the timeline, and users with a larger inflow rate of tweets have lower probabilities of resharing content.

Monotony Aversion

To maximize visibility in the face of limited attention in online social networks, a naive strategy is to rapidly broadcast, completely filling every follower's timeline. This raises the concern of irritation on viewing a monotonous timeline dominated by a single user's posts. The phenomenon of users exhibiting irritation with monotony, is referred to herein as “monotony aversion,” and makes brief appearances in a number of studies.

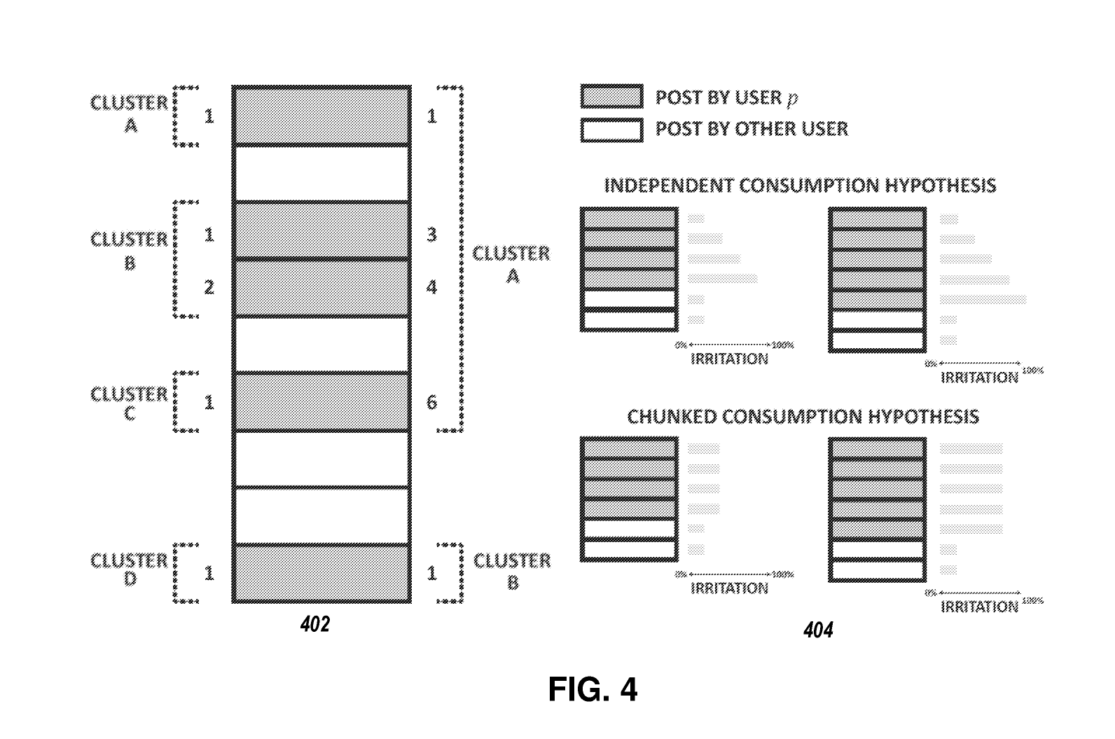

As used herein, a strict interpretation of the term “cluster” refers to a group of consecutive tweets on a timeline having the same author, termed the cluster author. However, perfectly consecutive clusters tend to be rare. Thus, it is possible to relax that requirement by defining a cluster tolerance: this is the number of tweets by other users that may appear between any pair of the cluster author's tweets without breaking the cluster up. The cluster size is then the number of tweets in a cluster. The cluster position of a tweet is its distance from the top of the cluster downwards, such that the chronologically newest tweet is at cluster position 1. These definitions are illustrated in FIG. 4, element 402. Since a tweet that is retweeted must have been viewed, it is possible to use retweets as a proxy for attention. This is a conservative measure because users generally retweet only a small fraction of the tweets that they view.

To demonstrate the validity of monotony aversion, the inventors used the Twitter-Friends dataset from S. Lin, et al., Steering information diffusion dynamically against user attention limitation, published in ICDM 2014. This data set consists of a follow-graph induced by 822 users having 56,286 links and all the tweets posted by them in the year 2011. The network is dense, with most users being current or former Twitter employees and active Twitter users. Restricting attention to regular individuals whose tweets may or may not receive attention reduces the likelihood of misleading data, as tweets by special users such as celebrities and news channels are actively sought out by fans and would benefit little from scheduling. Since each tweet is time stamped, it is possible to construct the entire timeline for any user by aggregating and reverse-chronologically sorting all the tweets by the users she follows. Hence, for any tweet on a user's timeline, it is possible to calculate its cluster size and cluster position by looking at the authors of its neighboring tweets. Table 1 displays some statistics of the tweet clusters in this dataset.

TABLE 1
Twitter-Friends tweet cluster statistics.

| Cluster Size | # Retweets | # Total Tweets |
|---|---|---|
| 1 | 3389 | 8435832 |
| 2 | 352 | 1819014 |
| 3 | 76 | 586665 |
| 4 | 34 | 243536 |
| 5 | 14 | 126125 |
| 6 | 9 | 72486 |
| 7 | 7 | 49119 |
| 8 | 3 | 26376 |
| 9 | 4 | 17019 |
| 10 | 5 | 13600 |
| >10 | 2 | 49673 |

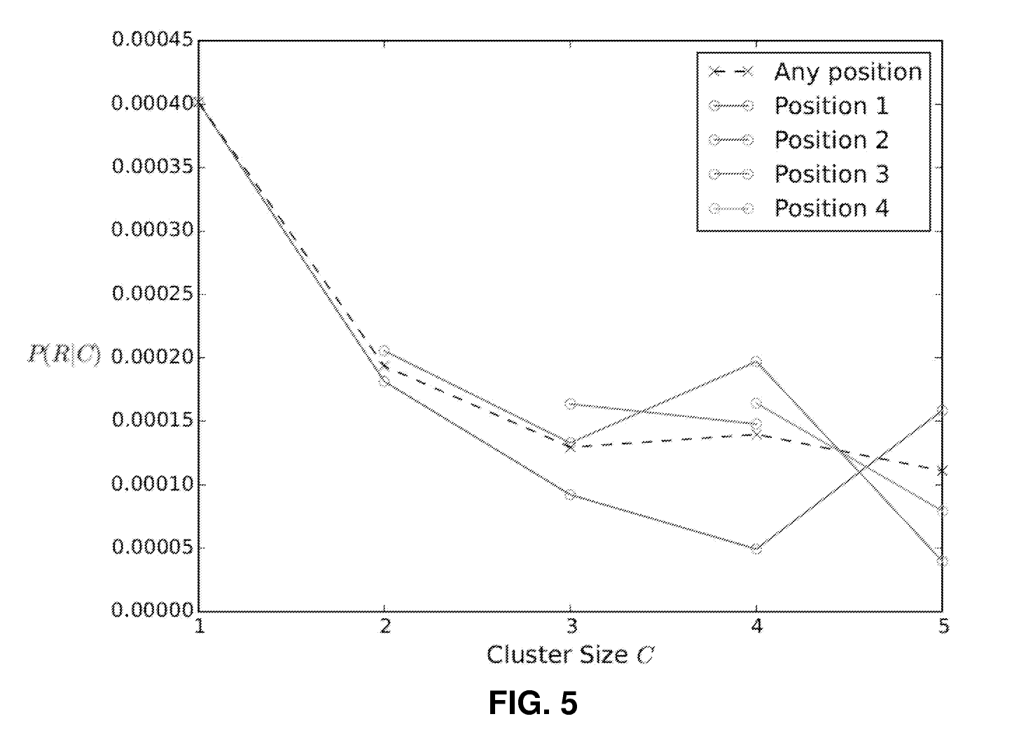

To observe if and how the cluster size and cluster position of a tweet influence its chances of being retweeted, let Rε{True, False} be the event of being retweeted and C the cluster size. We focus first on the empirical probability of being retweeted from a given cluster size, P(R|C), depicted by the dotted line in FIG. 5. As can be seen, the chances of being retweeted reduce as the cluster size increases, suggesting that to obtain more retweets it is wise to enforce a delay between consecutive tweets, allowing other users to intersperse their tweets between yours and keep the cluster size low.

However, it is possible that this decrease in retweets is simply due to the relative rarity of larger clusters. Hence, the inventors conducted a statistical randomization test evaluating the null hypothesis that the cluster size has no bearing on the retweet probability. The observed test statistic is shown in Table 2A. We then generate 1000 random permutations of tweets across cluster sizes to construct our null models and compute p-values, shown in Table 2B. The observed test statistic (in Table 2A) and p-values for the null hypothesis (in Table 2B). Cell (i,j)(i; j) contains (in Table 2A) T_{obs} j)=P(R|C=−P(R|C=j) and (in Table 2B) the probability that T_{obs} (i,j) is due to chance, where R is the event of being retweeted and C is the cluster size. Bold probabilities are significant (p<0.05).

TABLE 2A

| | j = 1 | j = 2 | j = 3 | j = 4 | j = 5 |
|---|---|---|---|---|---|
| i = 1 | — | 0.0002 | 0.0003 | 0.0003 | 0.0003 |
| i = 2 | — | — | 6.4e−05 | 5.5e−05 | 8.25e−05 |
| i = 3 | — | — | — | −1e−05 | 1..85e−05 |
| i = 4 | — | — | — | — | 2.86e−05 |
| i = 5 | — | — | — | — | — |

TABLE 2B

| | j = 1 | j = 2 | j = 3 | j = 4 | j = 5 |
|---|---|---|---|---|---|
| i = 1 | — | 0.001 | 0.001 | 0.001 | 0.001 |
| i = 2 | — | — | 0.004 | 0.079 | 0.059 |
| i = 3 | — | — | — | 0.577 | 0.393 |
| i = 4 | — | — | — | — | 0.353 |
| i = 5 | — | — | — | — | — |

We can thus be reasonably confident that P(R|C=1)>P(R|C=2)>P(R|C=3)) is not due to chance. However, when dealing with retweet probabilities for clusters of size 4 and greater, we can no longer reject the null hypothesis. This may explain the noisy disruption in trends for C>3 in FIG. 5. However, clusters with C>3 give rise to less than 6% of all tweets in this dataset, so our hypothesis holds for the large majority that remains. A potential root cause of large clusters in our data is noise; tweets missing in the data could have broken large clusters into smaller ones had they been present.

We now focus on the following question: are the chances of a tweet being retweeted affected by the number of tweets below it in the same cluster? We would not expect this if users consume tweets sequentially and independently, which we term the independent consumption hypothesis. However, the solid lines in FIG. 5 indicate that, given a fixed cluster position, retweet probability decreases with increasing cluster size. This supports the alternative chunked consumption hypothesis, under which users view their timeline in chunks whose sizes influence their attention towards each individual tweet. Specifically, one cannot tweet creating large clusters and still expect the newest tweets in that cluster to command the same attention; there is a reasonable chance of the user skipping over the entire cluster of tweets in irritation.

The results above quantitatively validate the presence of irritation and loss of attention reported by earlier qualitative studies. They reveal the trade-off that a broadcaster must make between creating large and visible but irritating clusters, and small, less visible clusters that command more attention. While our results suggest that the irritated user inattentively skims over offending tweet clusters, large tweet bursts have been reported as the most common reason to unfollow someone on Twitter. Hence, it is essential for a broadcast scheduling algorithm to intelligently control the perceived spacing of tweets on followers' timelines.

Bursty Circadian Rhythms

In many scenarios, such as sending email or blogging, humans have been observed to perform actions in bursts. The inter-event times in such scenarios are characterized by a power law distribution, arising from bursts of activity followed by long periods of inactivity. This distribution of inter-event times could not be explained by the Poisson model that is commonly used for human activities. An alternative proposed a priority queue model of human decision making and successfully validated it on an email communication corpus. However, this model did not take into account the effect of circadian rhythms: oscillations influenced by the sleep-cycle and daily routine that take place with a period of 24 hours. Circadian rhythms give rise to periodic deviations from the aforementioned power-law curve. Bursty circadian activity is widely accepted to be an intrinsic part of human nature, but whether such behavior is manifest in online social networks has been heretofore unexplored. Towards this end, we analyze the inter-event time distribution of tweets from Sina Weibo: a popular microblogging platform.

We extract tweet timestamps for every user in the Weibo-scope dataset [9] and perform no additional filtering, leaving us with a collection of over 13 million tweets sent by over 14 million users during the entire year 2012. This is the first online social network dataset under study for bursty circadian activity, and also the largest and temporally longest dataset used to validate this phenomenon.

Experiments

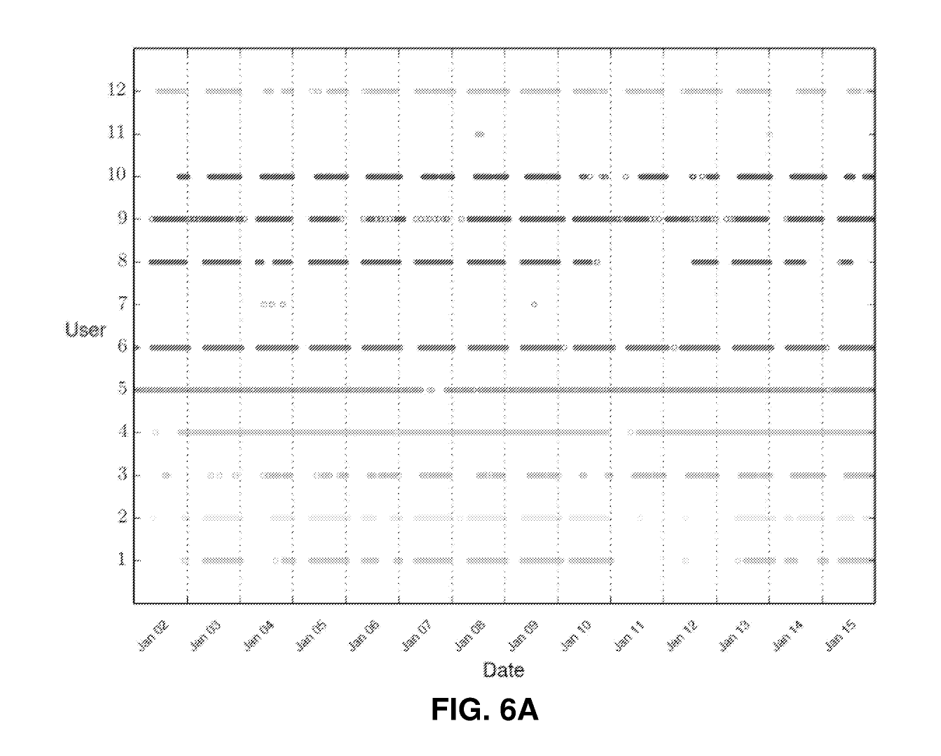

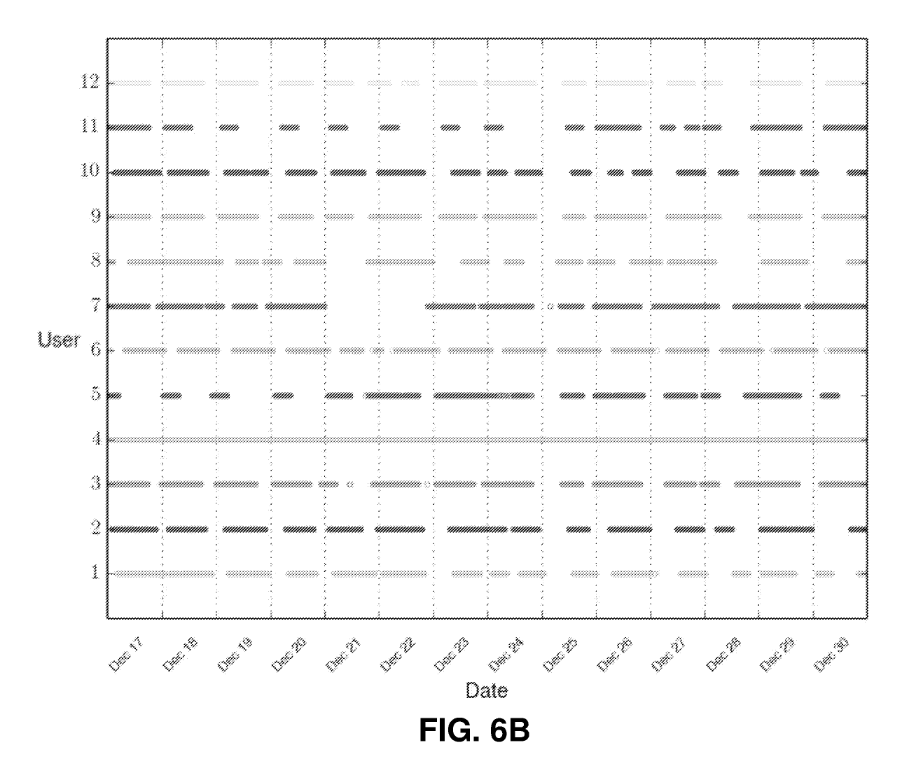

To gain some initial intuition, we observe the tweeting activity of the top 12 users with the most tweets for the first (FIG. 6A) and last (FIG. 6B) two weeks of 2012. Bursty activity is evident; users may have a single or multiple tweet bursts per day, separated by long inactive intervals. Interestingly, some users appear to tweet throughout the day, while some have unusually perfect periodicity, suggesting the presence of automated tweet bots.

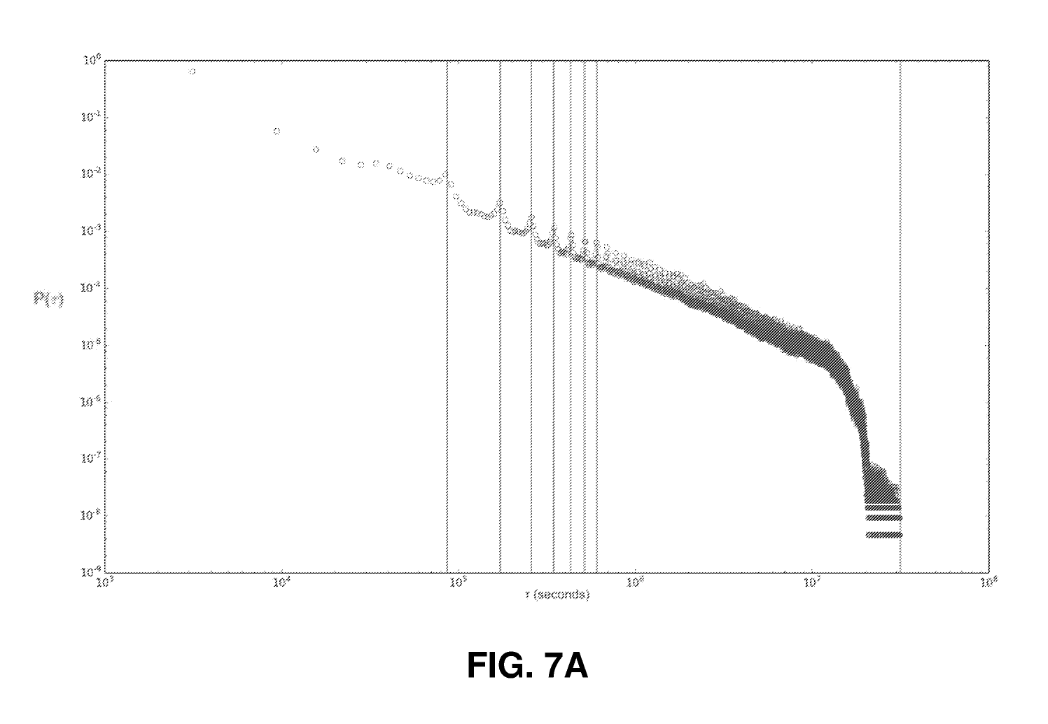

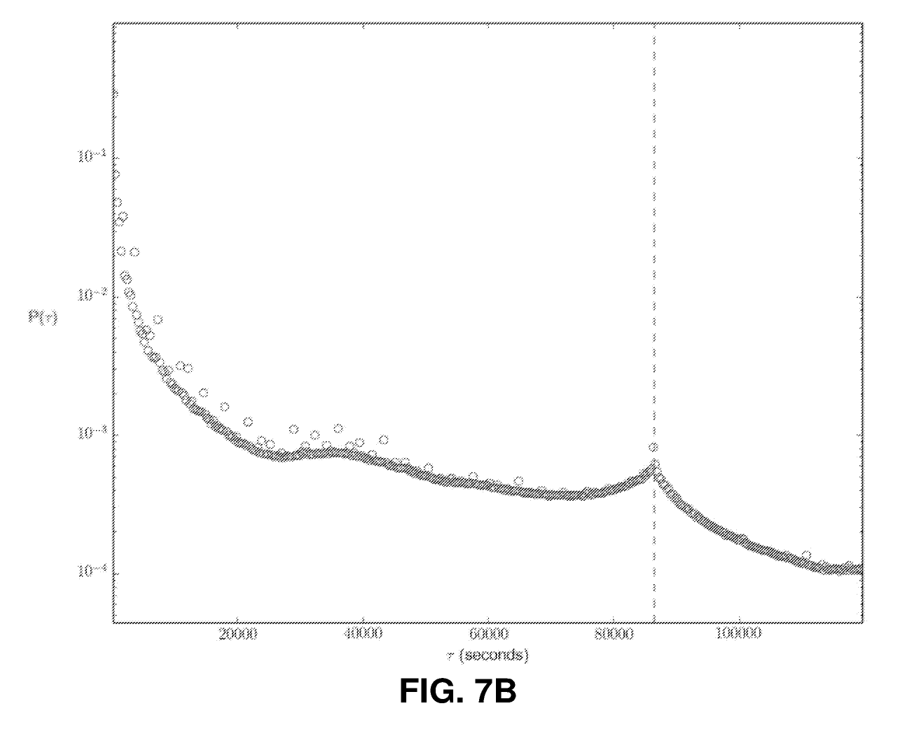

Circadian rhythms are, however, less evident in this plot. Hence in FIG. 7A, we observe the distribution of the inter-event time τ between successive tweets for all users in the dataset. The plot follows a power-law curve until τ=1 day (the first red vertical line), and a skewed curve henceforth with a heavy tail. The periodic deviations from the power-law curve after τ=1, with a 24-hour period, is characteristic of circadian rhythms modulating bursty user activity.

If we zoom in on the curve in the interval before τ=1 day (FIG. 7B), we notice a local minimum at around τ=7 hours. This indicates the lower probability of having a 7 hour gap between tweets when compared to an 8-10 hour gap. With 8-10 hours being the length of an average workday, it is naturally more likely that one resumes tweeting after a gap of this length. A similarly placed local minimum has been observed in a recent study on multiplayer gaming activity.

The Broadcast Scheduling Problem

The interplay between the actions of the following entities in the social network collectively leads to the construction of each user's timeline:

1. The producer, whose broadcast schedule is optimized in embodiments herein. This is usually a blogger, celebrity or other publicity seeker with some finite number of posts to be broadcast every day, hoping to maximize the total number of reactions she receives.

2. A target user; there may be many target users, all of whom subscribe to updates from the producer. They are called followers on Twitter and Instagram, and friends on Facebook. They exhibit different degrees of information overload, aversion to monotony and circadian rhythms; these must be estimated for each target user from their social network activity.

3. Competitors, who are other users followed by each target user. Since target users may follow different sets of users, competitors are always considered with respect to a specific target user. Competitors also have broadcast schedules, and the aggregate activity of competitors for a given target user can be estimated from the target user's timeline.

The producer has partial control over each target user's timeline and, together with the competitors, constructs the target user's timeline as a reverse-chronologically ordered sequence of posts. While optimizing for a single target user is relatively easy, the constraint of broadcasts forces the producer to have the same schedule for all target users. Hence, this schedule must strike a balance between target users with different competitors, circadian rhythms and degrees of information overload and monotony aversion.

We first formalize these interactions by introducing parameters for the above entities that capture their behavior in the network. For a given configuration of parameters, we then formulate the value of a timeline constructed for a given target user, which is proportional to the attention the producer can expect to receive from this target user. Summing over these timeline values finally gives us our objective function, which we then show how to maximize.

Timeline Construction

A first focus is on the behavior of the producer, who desires a schedule specifying how many posts to broadcast at each instant of the day. It may be assumed that this schedule is then repeated every day. This assumption is simplifying but not restrictive, since the formulation works even for schedules that stretch over periods of weeks or months, as long as they recur after this time period. If we discretize a day into S time slots, a broadcast schedule is then a set X={x₀, . . . , X_{S-1}}, where xᵢ≧0 is the number of posts broadcast in time slot i. Let N be the number of posts intended to be broadcast each day. It may not be optimal to broadcast all of one's intended posts, so Σᵢ₌₀^{S-1}xᵢ≦N.

The competitors, similarly, have broadcast schedules. However, it is not necessary to know the individual competitor schedules; instead, one must know the total number of posts produced by all competitors for a given target user in a specific time slot. For time slot i and target user j, we denote this number by cᵢⱼ, and we have an aggregate competitors schedule Cⱼ={c₀ⱼ, . . . , s_{(S-1)}j}. Note that cᵢⱼ>0; otherwise the scenario reduces to an equivalent one with S−1 slots.

We adopt the following formalization of the timeline construction process of target user j: in time slot i, the producer first broadcasts xᵢ posts, and the competitors then collectively broadcast cⱼ posts, which appear above the producer's posts in the timeline by virtue of being more recent. This repeats for slot i+1, eventually wrapping around to slot 0 at the beginning of the next day. The process continues indefinitely, leading to an infinite interleaved sequence of posts by the producer and competitors.

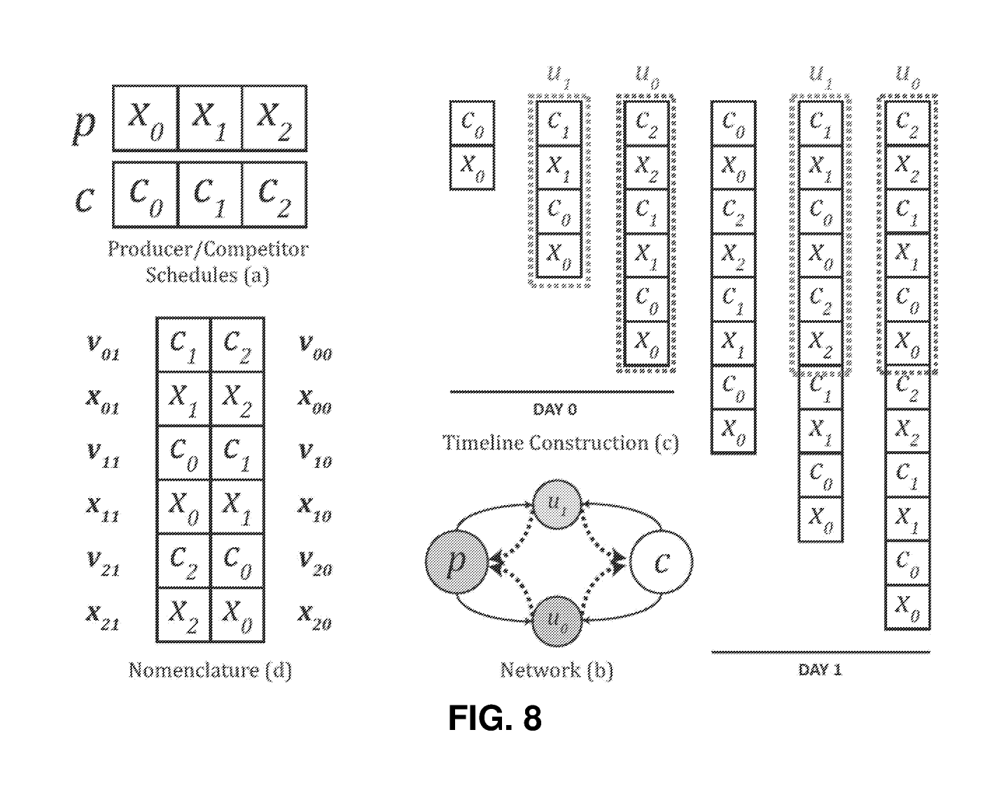

FIG. 8 illustrates this process. Depicted is a network (b) with a single competitor c followed by two target users u₀ and u₁. There are 3 slots in total (S=3). The producer schedule X and competitor schedule C are depicted in (a). Since both target users have the same competitors, we drop the subscript for the competitor schedule and the timeline construction process (c) is common to both.

Timeline Consumption and Value

It is assumed that users login to the social network and consume their timelines once in a day, based on the observations described above. While this assumption simplifies the framework, it can be extended to scenarios with multiple logins per day. Concretely, user j logs in at the end of time slot σⱼ ε{0, . . . ,S−1} and begins consuming her timeline from the top downwards. She scrolls down at most until the first post she viewed the previous day; Twitter, in fact, graphically marks this point to indicate posts below that have already been viewed. The chunk of the timeline that the user can maximally consume is herein referred to as a timeline segment. On every login, the user partially consumes a timeline segment containing interleaved clusters of posts by the producer and competitors. The order of clusters and number of posts in each cluster that the user sees on login remains the same each day (on average, since each Cⱼ is an estimate from historical observations). Let there be xᵢⱼ producer posts in the cluster at position i (from the top) for user j, and vᵢⱼ competitor posts right above it. The number of posts in a cluster will be related with the producer and consumer schedules later in this section.

FIG. 8 illustrates this nomenclature and the consumption process. Target users u₀ and u₁ log in at time slot 2 and 1 respectively (σ₀=2, σ₁₌₁). On day 0, u₁ consumes her timeline segment (marked in green) in slot 1 for the first time, which stabilizes on day 2 and remains the same every day henceforth. Similarly, u₀ consumes her timeline segment (marked in blue) in slot 2. The stable timeline segments are depicted in (d), with the post clusters labeled according to our nomenclature.

The extent to which the user scrolls down the timeline segment depends on her degree of information overload. We define a parameter ρⱼ ε(0,1) for each user j, which captures how prematurely the user quits consuming the timeline. ρ₁ Σ{0,1} corresponds to full timeline consumption and no timeline consumption, respectively. This parameter can be estimated from behavioral observations, like the average number of posts she consumes after login, or structural observations, like the number of users she follows. We denote the user as having survived until depth d if she consumes the timeline at least until this depth. We define a user survival function R(d; ρ₁) that quantifies the probability of the user j surviving until depth d. The form of this function could be any used in survival analysis (e.g., the exponential, Weibull, negative binomial, geometric survival functions, or the like). Some example functions are illustrated in Table 3.

TABLE 3

| Model | Survival Function | |
|---|---|---|
| Exponential(λ) | e^{-λx}, | λ > 0, x ≧ 0 |
| Geometric(λ) | ${( 1 - λ )}^{x} ,$ | 0 < λ ≦ 1, x ≧ 0 |
| Weibull(λ, p) | e^{-λx}^{^{P}}, | λ > 0, p > 0, x ≧ 0 |
| Log-logistic(λ) | $\frac{1}{1 + λxP} ,$ | λ > 0, \| p > 0, x ≧ 0 |
| Rayleigh(λ) | $\frac{- {x}^{2}}{{e}^{2 {λ}^{2}}} ,$ | λ > 0, x ≧ 0 |

In addition to user survival, we also consider the notion of cluster survival. We denote a cluster of posts as having survived for a specific user if it has not been skipped over by that user due to crossing the user's irritation threshold. To capture how easily a user j is irritated and skips a cluster, we define a parameter δⱼ ε[0,1]; δⱼ ε{0,1} correspond to always and never skipping clusters, respectively. We define a cluster survival function W(x, δⱼ) that quantifies the probability of a cluster with x posts surviving user j. As with the user survival function, any of the forms used in survival analysis could be used for the cluster survival function. The degree of monotony aversion δⱼ can also be estimated from structural and behavioral parameters, such as the tie strength or interaction frequency with the producer.

We are now in position to introduce the concept of attention potential. For a single post at depth d to be viewed by a specific user, the user must (i) consume the timeline until depth d, and (ii) not skip the cluster containing this post. Concretely, a post is given attention if the user survives until that post and the cluster containing that post survives for that user. Since these events are independent, the probability of this happening for a user j is given by R(d; ρⱼ)W(x,δⱼ), which is the attention potential of a post at depth d for user j.

The attention potential of a cluster is the sum of attention potentials of the posts within it. Given a cluster containing xᵢⱼ posts, let there be a total of zᵢⱼ posts on the timeline above the first post in this cluster. The attention potential of this cluster is given by the following function of the producer schedule:

$${f}_{ij} ( X ) = W ( {x}_{ij} , {δ}_{j} ) {\sum }_{k = 1}^{{x}_{ij}} R ( {z}_{ij} + k ; {ρ}_{j} ) \qquad ( 1 )$$

In one example, we utilize a geometric survival function and exclude the degenerate cases ρⱼ ε{0,1}. Hence, the attention potential of a post at depth d is discounted by a factor (1−ρⱼ)^{d}, which decreases with increasing depth. Thus, in this example, the attention potential of this cluster (without yet considering cluster survival) is given by the following function:

$${f}_{ij} ( X ) = {\sum }_{k = 1}^{{x}_{ij}} {( 1 - {ρ}_{j} )}^{{z}_{ij} + ( k - 1 )} = {( 1 - {ρ}_{j} )}^{{z}_{ij}} ( \frac{1 - {( 1 - {ρ}_{j} )}^{{x}_{ij}}}{{ρ}_{j}} )$$

In this example, we might discount every post in the cluster by a factor δⱼ ε(0,1) in proportion to the number of posts within it. This is based on the chunked consumption hypothesis. We again exclude the degenerate cases δⱼ ε{0,1} corresponding to always and never skipping clusters, respectively. The attention potential of the cluster now becomes:

$${f}_{ij} ( X ) = {{δ}_{j}^{{x}_{ij}} ( 1 - {ρ}_{j} )}^{{z}_{ij} )} ( \frac{1 - {( 1 - ρ )}^{{x}_{ij}}}{{ρ}_{j}} ) \qquad ( 1 )$$

The number of posts above the first post in the cluster is easily specified:

$${z}_{ij} = {\sum }_{m = 0}^{i - 1} {x}_{mj} + {\sum }_{n = 0}^{i} {v}_{nj} \qquad ( 2 )$$

What remains is to derive the number of producer posts xᵢⱼ and competitor posts vᵢⱼ in the cluster from the producer schedule X and aggregate competitor schedules Cⱼ respectively. The following relations hold:

xᵢⱼ=x((σⱼ−1)mod S)) (3)

vᵢⱼ=c((σⱼ−1)mod S))j (4)

In this regard, the term mod refers to the binary modulus that returns the remainder when its second argument is divided by the first.

The attention potential of the timeline constructed for a given target user j is simply the sum of the attention potentials Σ of all the producer's clusters on that timeline, Σᵢ₌₀^{S-1}ƒᵢⱼ(X).

Optimization

The producer wishes to maximize the attention she expects to receive from all her target users. For a single target user, a balance must be struck between annoying the user and gaining her attention. Additionally, a balance must be struck across all target users, who may have different parameters in our model. Both of these are captured by the value of the timeline defined in the previous section. If there are U target users in total, we want to maximize the attention potentials of all target user timelines, F(X)=Σᵢ₌₀^{S-1}Σⱼ₌₀^{U-1}ƒᵢⱼ(X). We can formulate this optimization problem as the following nonlinear integer program:

$${maximise}_{X} F ( X )$$

$$subject to {\sum }_{{x}_{1} ∈ X} {x}_{i} \leq N , \\ X ⊆ {ℤ}_{+}^{s} .$$

Since the objective function is continuous and differentiable over R₊^{S} and there is a single affine constraint, this becomes an instance of the nonlinear knapsack problem. Though a number of variants have been studied in the resource allocation literature, our objective function is nonseparable, making it a relatively unexplored scenario. It is also nonconcave, and not even quasiconcave, over both nonnegative reals and integers. These characteristics place the problem outside the realm for which efficient general algorithms have been devised. Hence, we look towards heuristics and local optimization methods.

However, the size of the discrete state space of the problem is O(N^{S}) with S time slots and N posts in total. In practice, the number of time slots S is fixed to be 24 (schedule every hour) or 1440 (schedule every minute). The number of total posts N depends on the specific producer, but larger values of N have been shown to draw lesser attention; a popular heuristic used by business is 2-3 posts a day. Additionally, schedules need to be recomputed fairly infrequently, typically on the addition of new followers. Hence, it may be computationally feasible in practice to exhaustively enumerate the search space whenever a new schedule is needed.

If one is computationally constrained, greedily exploring the discrete state space is a common local optimization strategy. For constrained integer programs, greedy algorithms are typically applications of the method of marginal allocation. When adapted to our problem, this corresponds to the following simple algorithm:

Algorithm 1: Marginal Allocation

| Input: Constraint N, initial solution X⁰ ∈ [symbol] ₊^{S} | | |
|---|---|---|
| begin | | |
| \| | Y ← X⁰ | |
| \| | Yₚᵣₑᵥ ← X⁰ | |
| \| | Δ ← 0 | |
| \| | repeat | |
| \| | \| | i ← argmaxₖ F(Y + eₖ) − F(Y) |
| \| | \| | Yₚᵣₑᵥ ← Y |
| \| | \| | Y ← Y + eᵣ |
| \| | \| | Δ ← Y − Yₚᵣₑᵥ |

| | |
|---|---|
| \| | until Δ ≦ 0 or Σ_{y∈Y} y > N |
| \| | return Yₚᵣₑᵥ |

end

Here, eₖ ε [symbol] ^{S} is the k^{th} unit vector. In each iteration, the algorithm adds a single post to the slot which results in the maximum increase in the objective function value. It terminates when adding a post to any slot either violates the total intended posts constraint or does not improve the objective function value. Essentially, this is a hill-climbing algorithm starting from the initial solution and is guaranteed to return an optimum, which may be local.

A number of other techniques exist to find local optima in general nonlinear optimization problems, such as branch-and-bound, simulated annealing and hill-climbing. The best one to apply depends on the specific user and computational constraints. In any case, if one desires an optimal solution, exhaustive enumeration of the state space defined by our optimization problem is the way to go. Starting from the example described above, one mechanism for optimization might be based on relaxation and promotion, as follows.

Relaxation and Promotion

An overall strategy is to relax the problem to one that is more tractable, solving which provides us an initial feasible solution. Subsequently, it is possible to greedily improve this solution via promotions, eventually terminating at an optimum. Ideally, the initial solution is situated such that greedy exploration from this point will always find the global optimum. This depends on the specific relaxation and the characteristics of the objective function. A goal is to find such a relaxation and also obtain bounds on the quality of the solution.

We first focus on the nonseparability of the objective function. Observe from equation (1) that this nonseparability arises from the zᵢⱼ term. We can eliminate it by ignoring the effect of decreasing attention with timeline depth, which corresponds to setting ρⱼ=1,∀j. This results in a relaxed objective function:

$$\begin{matrix}{\overline{f}}_{ij} ( {x}_{ij} ) = {δ}_{j}^{{x}_{ij}} {x}_{ij} & ( 5 ) \\ {\overline{F}}_{ij} ( X ) = {\sum }_{i = 0}^{S - 1} {\sum }_{j = 0}^{U - 1} {\overline{f}}_{ij} ( X ) & ( 6 )\end{matrix}$$

The resulting function ƒ̅ᵢⱼ(xᵢⱼ) is sigmoidal: there exists a y ε [symbol] such that ƒ̅ᵢⱼ(xᵢⱼ) is convex for xᵢⱼ≦y and concave for xᵢⱼ≧y. In our case, y=−(log(δᵢⱼ))⁻¹. Our relaxed objective function is hence a separable sum of sigmoidal functions. If we further relax the integer constraint on X, the problem becomes an instance of the recently introduced class of sigmoidal programming problems. General methods for solving these problems exist, which provide both polynomial-time approximate solutions with provable bounds, and globally optimal solutions in exponential time. They are also fast in practice when there are few constraints, making it a particularly suitable relaxation for our problem.

Since our relaxation ignores the loss of attention due to depth, the initial solution will contain posts in lower in the timeline that could benefit from being promoted higher. We greedily perform post promotions in a manner similar to marginal allocation. We iteratively select a pair of slots such that promoting a post from one slot to the other results in the maximum increase in the objective function value. We terminate when no promotion can improve the objective.

### Operations Performed by a Computing Device to Maximize Consumption of a Producer's Content

Having stepped through a description of the algorithms used in example embodiments of the present invention, FIGS. 9 through 16 illustrate flowcharts containing a series of operations performed by example embodiments described herein to determine time slots in which to transmit broadcasts and how many broadcasts to transmit in each time slot. By doing so, example embodiments are configured to maximize consumption of a producer's content. The operations shown in FIGS. 9 through 16 are performed in an example embodiment by an apparatus 100 that may be embodied by or otherwise associated with processing circuitry 102 (which may include a processor 104 and a memory 106), a user interface 108, and in some embodiments, a communication interface 110.

In operation 902, the computing device 100 includes means, such as processing circuitry 102, user interface 108, communication interface 110, or the like, for receiving selection of a total number of time slots to use for scheduling broadcasts. In some embodiments, this selection may be retrieved from a memory within processing circuitry 102. In other embodiments, this selection may be received directly from a producer via user interface 108. In yet other embodiments (e.g., when the consumer is located remotely from the computing device 100), this selection may be received from a remote computing device via communication interface 110.

In operation 904, the computing device 100 includes means, such as processing circuitry 102, user interface 108, communication interface 110, or the like, for receiving information regarding the producer's followers. This information may include one or more of: information regarding a set of producers followed by each of the producer's followers, information regarding broadcasts transmitted by each of the producer's followers, and information regarding timelines of each of the producer's followers. As with operation 902, in some embodiments, this information may be retrieved from a memory within processing circuitry 102, from a producer via user interface 108, or from a remote computing device via communication interface 110.

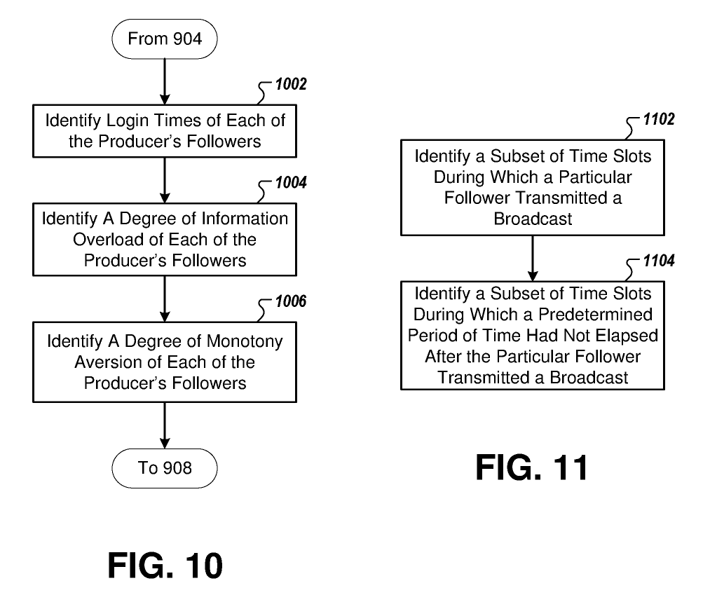

In operation 906, the computing device 100 includes means, such as processing circuitry 102, user interface 108, communication interface 110, or the like, for identifying, based on the received information, discount factors associated with the producer's followers. While in some embodiments, the discount factors may be identified by the computing device 100 (as described in greater detail in FIGS. 10 through 13), in other embodiments, the discount factors may be retrieved from a user interface 108 or communication interface 110.

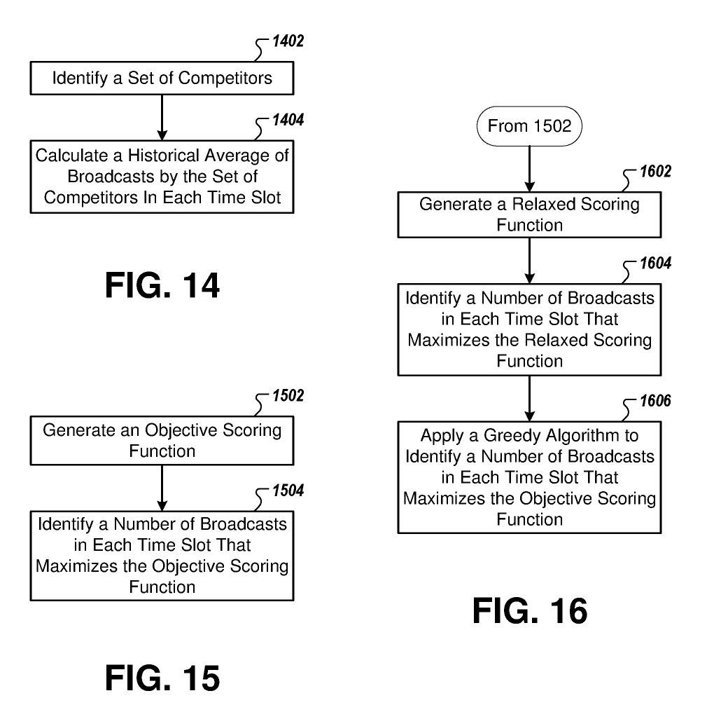

In operation 908, the computing device 100 includes means, such as processing circuitry 102 or the like, for calculating, based on the received information, a predicted number of competitor broadcasts during each time slot of the total number of time slots. Calculating the predicted number of competitor broadcasts is described in greater detail below in conjunction with FIG. 14.

In operation 910, the computing device 100 includes means, such as processing circuitry 102, or the like, for determining, based on the discount factors and the predicted number of competitor broadcasts during each time slot, a number of broadcasts for the producer to transmit in each time slot of the total number of time slots. Determining the number of broadcasts for the producer to transmit in each time slot is described in greater detail below in conjunction with FIGS. 15 and 16 below.

Finally, in optional operation 912, the computing device 100 may include means, such as processing circuitry 102, communication interface 110, or the like, for causing transmission of the determined number of broadcasts in each time slot of the total number of time slots. In this regard, the computing device 100 may itself transmit these broadcasts via communication interface 110. Alternatively, the computing device 100 may issue an instruction to another device to transmit the broadcasts. In either case, by transmitted the broadcasts in accordance with the determination of the number of broadcasts for the producer to transmit in each time slot of the total number of time slots, embodiments described herein maximize the likelihood of consumption of the producer's content.

Turning now to FIG. 10, example operations are illustrated that provide greater insight into the identification discount factors associated with a producer's followers, in accordance with some example embodiments of the present invention. In operation 1002, the computing device 100 includes means, such as processing circuitry 102 or the like, for identifying login times of a producer's followers. In operation 1004, the computing device 100 includes means, such as processing circuitry 102 or the like, for identifying degrees of information overload of a producer's followers. Finally, in operation 1006, the computing device 100 includes means, such as processing circuitry 102 or the like, for identifying degrees of monotony aversion of a producer's followers. Each operation is described in greater detail in connection with FIGS. 11 through 13, respectively.

Turning now to FIG. 11, example operations are illustrated for identifying login times of a producer's followers, in accordance with some example embodiments of the present invention. The operations described in connection with FIG. 11 illustrate a procedure to identify the login time for each particular follower of the producer's followers. Identifying the login times for all of the producer's followers thus requires performance of these operations in connection with each follower.

In operation 1102, the computing device 100 includes means, such as processing circuitry 102 or the like, for identifying, based on the received information regarding the producer's followers, a first subset of the time slots during which the particular follower transmitted a broadcast. Subsequently, in operation 1104, the computing device 100 includes means, such as processing circuitry 102 or the like, for identifying, based on the received information regarding the producer's followers, a second subset of time slots during which a predetermined period of time had not elapsed after the particular follower transmitted a broadcast. The login times of the particular follower comprises a union of the first subset of time slots and the second subset of time slots.

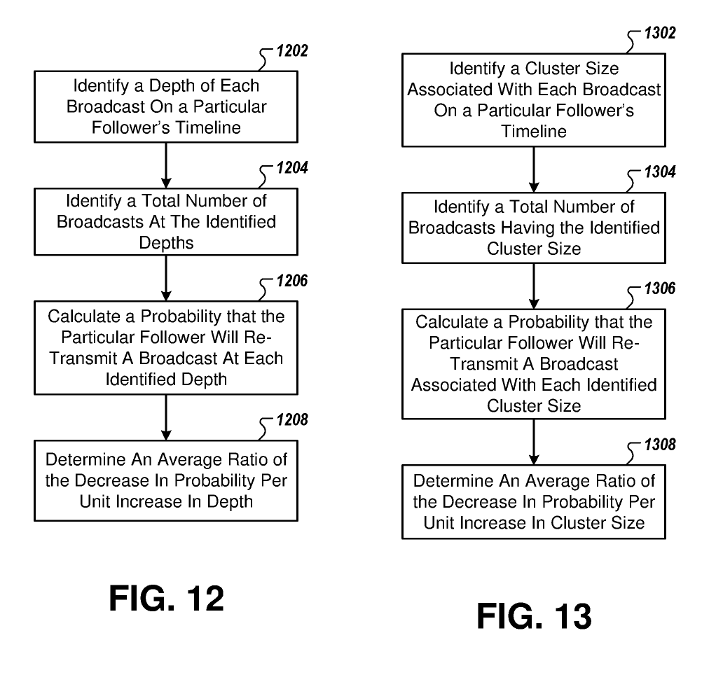

Turning now to FIG. 12, example operations are illustrated for identifying degrees of information overload of a producer's followers, in accordance with some example embodiments of the present invention. The operations described in connection with FIG. 12 illustrate a procedure to identify the degree of information overload of each particular follower of the producer's followers. Identifying the degrees of information overload for all of the producer's followers thus requires performance of these operations in connection with each follower.

In operation 1202, the computing device 100 includes means, such as processing circuitry 102 or the like, for identifying, based on the received information regarding the producer's followers, a depth of each broadcast on the timeline of the particular follower that was re-transmitted by the particular follower.

In operation 1204, the computing device 100 includes means, such as processing circuitry 102 or the like, for identifying a total number of broadcasts on the timeline of the particular follower at each identified depth.

In operation 1206, the computing device 100 includes means, such as processing circuitry 102, user interface 108, communication interface 110, or the like, for calculating a probability that the particular follower will re-transmit a broadcast located at each of the identified depths. Finally, in operation 1208, the computing device 100 includes means, such as processing circuitry 102, user interface 108, communication interface 110, or the like, for determining an average ratio of a decrease in probability of re-transmission per unit increase in depth on the timeline of the particular follower. It should be understood that the degree of information overload of the particular follower comprises the determined average ratio.

Turning now to FIG. 13, example operations are illustrated for identifying degrees of monotony aversion of a producer's followers, in accordance with some example embodiments of the present invention. The operations described in connection with FIG. 12 illustrate a procedure to identify the degree of monotony aversion of each particular follower of the producer's followers. Identifying the degrees of monotony aversion for all of the producer's followers thus requires performance of these operations in connection with each follower.

In operation 1302, the computing device 100 includes means, such as processing circuitry 102, or the like, for identifying, based on the received information regarding the producer's followers, a cluster size associated with each broadcast on the timeline of the particular follower that was re-transmitted by the particular follower.

In operation 1304, the computing device 100 includes means, such as processing circuitry 102 or the like, for identifying a total number of broadcasts on the timeline of the particular follower associated with the identified cluster sizes.

In operation 1306, the computing device 100 includes means, such as processing circuitry 102 or the like, for calculating a probability that the particular follower will re-transmit a broadcast associated with each of the identified cluster sizes.

In operation 1308, the computing device 100 includes means, such as processing circuitry 102 or the like, for determining an average ratio of the decrease in probability of re-transmissions per unit increase in cluster size associated with a broadcast on the timeline of the particular follower. It should be understood that the degree of monotony aversion of the particular follower comprises this determined average ratio.

Turning now to FIG. 14, example operations are illustrated for calculating a predicted number of competitor broadcasts during each time slot, in accordance with some example embodiments of the present invention.

In operation 1402, the computing device 100 includes means, such as processing circuitry 102 or the like, for identifying, based on the received information regarding the producer's followers, a set of competitors

Subsequently, in operation 1404, the computing device 100 includes means, such as processing circuitry 102 or the like, for calculating a historical average number of broadcasts transmitted by the set of competitors in each time slot of the total number of time. It should be understood that the predicted number of broadcasts by competitors in each time slot of the total number of time slots may comprise the historical average number of broadcasts transmitted by the set of competitors in each time slot of the total number of time slots.

Turning now to FIG. 15, example operations are illustrated for determining a number of broadcasts for a producer to transmit in each time slot, in accordance with some example embodiments of the present invention.

In operation 1502, the computing device 100 includes means, such as processing circuitry 102 or the like, for generating an objective scoring function based on the discount factors and the number of competitor broadcasts in each time slot. Generation of this objective scoring function is described above.

Subsequently, in operation 1504, the computing device 100 includes means, such as processing circuitry 102 or the like, for identifying a number of broadcasts in each time slot of the total number of time slots that maximizes the objective scoring function. One example procedure for performing this identification is described in greater detail in connection with FIG. 16.

Accordingly, turning to FIG. 16, example operations are illustrated for identifying a number of broadcasts in each time slot that maximizes the objective scoring function, in accordance with some example embodiments of the present invention.

In operation 1602, the computing device 100 includes means, such as processing circuitry 102 or the like, for generating a relaxed scoring function by ignoring an impact of one of the discount factors. As described previously, this relaxed scoring function may ignore the impact of the follower information overload to simplify the computational capacity required to maximize the objective scoring function.

Thus, in operation 1604, the computing device 100 includes means, such as processing circuitry 102 or the like, for identifying a number of broadcasts in each time slot of the total number of time slots that maximizes the relaxed scoring function.

As a result, in operation 1606, the computing device 100 includes means, such as processing circuitry 102, user interface 108, communication interface 110, or the like, for applying, based on the number of broadcasts in each time slot of the total number of time slots that maximizes the relaxed scoring function, a greedy algorithm to identify the number of broadcasts in each time slot of the total number of time slots that maximizes the objective scoring function. An example of one such greedy algorithm is described above.

Accordingly, the operations illustrated in FIGS. 9 through 16 provide a procedure that maximizes consumption of a producer's broadcasts on a social networking service. Because the global economy continues to rely more heavily on information sharing, and social interaction increasingly occurs via online social networking services, a lot can be gained through the careful scheduling of posts tailored to one's followers. By enabling a producer to maximize the consumption of transmitted broadcasts, embodiments described herein thus increase opportunities for personal fulfillment, increased advertising effectiveness, and increased organic reach.

The above-described flowcharts illustrate operations performed by an apparatus (which include the hardware elements of computing device 100 of FIG. 1), in accordance with some example embodiments of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by program code instructions. In this regard, the program code instructions which embody the procedures described above may be stored by a memory 106 of the computing device 100 employing an embodiment of the present invention and executed by a processor 104 of the computing device 100. As will be appreciated, loading these program code instructions onto a computing device 100 produces a specially programmed apparatus configured to implement the functions specified in the respective flowchart blocks. The program code instructions may also be stored in a non-transitory computer-readable storage medium that may direct a computer or other programmable apparatus to function in the prescribed manner, such that storing the program code instructions in the computer-readable storage memory produce an article of manufacture which can be accessed by an computing device 100 to implement the functions specified in the flowchart blocks. Accordingly, the operations illustrated in the flowchart define algorithms for configuring a computer or processing circuitry 102 (e.g., a processor) to perform example embodiments described above. When a general purpose computer stores the algorithms illustrated above, the general purpose computer is transformed into a particular machine configured to perform the corresponding functions.

Blocks of the flowchart support combinations of means for performing the specified functions and combinations of operations for performing the specified functions. It will be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for maximizing consumption of broadcasts by a producer, the method comprising:
receiving selection of a total number of time slots to use for scheduling broadcasts;
receiving information regarding the producer's followers;
identifying, by a processor and based on the received information, discount factors associated with the producer's followers;
calculating, by the processor and based on the received information, a predicted number of competitor broadcasts during each time slot of the total number of time slots; and
determining, by the processor and based on the discount factors and the predicted number of competitor broadcasts during each time slot, a number of broadcasts for the producer to transmit in each time slot of the total number of time slots.

2. The method of claim 1, further comprising:
causing transmission of the determined number of broadcasts in each time slot of the total number of time slots.

3. The method of claim 1, wherein the information regarding the producer's followers includes:
information regarding a set of producers followed by each of the producer's followers;
information regarding broadcasts transmitted by each of the producer's followers; and
information regarding timelines of each of the producer's followers.

4. The method of claim 1, wherein the discount factors associated with the producer's followers include login times of each of the producer's followers, a degree of information overload of each of the producer's followers, and a degree of monotony aversion of each of the producer's followers.

5. The method of claim 4, wherein identifying the login times of the producer's followers includes:
for each particular follower of the producer's followers,
identifying, based on the received information regarding the producer's followers, a first subset of the time slots during which the particular follower transmitted a broadcast; and
identifying, based on the received information regarding the producer's followers, a second subset of time slots during which a predetermined period of time had not elapsed after the particular follower transmitted a broadcast,
wherein the login times of the particular follower comprises a union of the first subset of time slots and the second subset of time slots.

6. The method of claim 4, wherein identifying the degrees of information overload of the producer's followers includes:
for each particular follower of the producer's followers,
identifying, based on the received information regarding the producer's followers, a depth of each broadcast on the timeline of the particular follower that was re-transmitted by the particular follower;
identifying a total number of broadcasts on the timeline of the particular follower at each identified depth;
calculating a probability that the particular follower will re-transmit a broadcast located at each of the identified depths; and
determining an average ratio of a decrease in probability of re-transmission per unit increase in depth on the timeline of the particular follower,
wherein the degree of information overload of the particular follower comprises the determined average ratio.

7. The method of claim 4, wherein identifying the degree of monotony aversion of each of the producer's followers includes:
for each particular follower of the producer's followers,
identifying, based on the received information regarding the producer's followers, a cluster size associated with each broadcast on the timeline of the particular follower that was re-transmitted by the particular follower;
identifying a total number of broadcasts on the timeline of the particular follower associated with the identified cluster sizes;
calculating a probability that the particular follower will re-transmit a broadcast associated with each of the identified cluster sizes; and
determining an average ratio of the decrease in probability of re-transmissions per unit increase in cluster size associated with a broadcast on the timeline of the particular follower,
wherein the degree of monotony of the particular follower comprises the determined average ratio.

8. The method of claim 1, wherein calculating the predicted number of competitor broadcasts during each time slot of the total number of time slots comprises:
identifying, based on the received information regarding the producer's followers, a set of competitors; and
calculating a historical average number of broadcasts transmitted by the set of competitors in each time slot of the total number of time slots,
wherein the predicted number of competitor broadcasts during each time slot of the total number of time slots comprises the historical average number of broadcasts transmitted by the set of competitors in each time slot of the total number of time slots.

9. The method of claim 1, wherein determining the number of broadcasts for the producer to transmit in each time slot includes:
generating an objective scoring function based on the discount factors and the predicted number of competitor broadcasts in each time slot; and
identifying a number of broadcasts in each time slot of the total number of time slots that maximizes the objective scoring function.

10. The method of claim 9, wherein identifying the number of broadcasts in each time slot of the total number of time slots that maximizes the objective scoring function includes:
generating a relaxed scoring function by ignoring an impact of one of the discount factors;
identifying a number of broadcasts in each time slot of the total number of time slots that maximizes the relaxed scoring function; and
applying, based on the number of broadcasts in each time slot of the total number of time slots that maximizes the relaxed scoring function, a greedy algorithm to identify the number of broadcasts in each time slot of the total number of time slots that maximizes the objective scoring function.

11. An apparatus for maximizing consumption of broadcasts by a producer, the apparatus comprising a processor and a memory storing program code instructions that, when executed by the processor, cause the apparatus to:
receive selection of a total number of time slots to use for scheduling broadcasts;
receive information regarding the producer's followers;
identify, based on the received information, discount factors associated with the producer's followers;
calculate, based on the received information, a predicted number of competitor broadcasts during each time slot of the total number of time slots; and
determine, based on the discount factors and the predicted number of competitor broadcasts during each time slot, a number of broadcasts for the producer to transmit in each time slot of the total number of time slots.

12. The apparatus of claim 11, wherein the program code instructions, when executed by the processor, further cause the apparatus to:
cause transmission of the determined number of broadcasts in each time slot of the total number of time slots.

13. The apparatus of claim 11, wherein the information regarding the producer's followers includes:
information regarding a set of producers followed by each of the producer's followers;
information regarding broadcasts transmitted by each of the producer's followers; and
information regarding timelines of each of the producer's followers.

14. (canceled)

15. The apparatus of claim 11, wherein the discount factors associated with the producer's followers include login times of each of the producer's followers, and wherein the program code instructions, when executed by the processor, cause the apparatus to identify the login times of the producer's followers by causing the apparatus to:
for each particular follower of the producer's followers,
identify, based on the received information regarding the producer's followers, a first subset of the time slots during which the particular follower transmitted a broadcast; and
identify, based on the received information regarding the producer's followers, a second subset of time slots during which a predetermined period of time had not elapsed after the particular follower transmitted a broadcast,
wherein the login times of the particular follower comprises a union of the first subset of time slots and the second subset of time slots.

16. The apparatus of claim 11, wherein the discount factors associated with the producer's followers include a degree of information overload of each of the producer's followers, wherein the program code instructions, when executed by the processor, cause the apparatus to identify the degrees of information overload of the producer's followers by causing the apparatus to:
for each particular follower of the producer's followers,
identify, based on the received information regarding the producer's followers, a depth of each broadcast on the timeline of the particular follower that was re-transmitted by the particular follower;
identify a total number of broadcasts on the timeline of the particular follower at each identified depth;
calculate a probability that the particular follower will re-transmit a broadcast located at each of the identified depths; and
determine an average ratio of a decrease in probability of re-transmission per unit increase in depth on the timeline of the particular follower,
wherein the degree of information overload of the particular follower comprises the determined average ratio.

17. The apparatus of claim 11, wherein the discount factors associated with the producer's followers include a degree of monotony aversion of each of the producer's followers, wherein the program code instructions, when executed by the processor, cause the apparatus to identify the degree of monotony aversion of each of the producer's followers by causing the apparatus to:
for each particular follower of the producer's followers,
identify, based on the received information regarding the producer's followers, a cluster size associated with each broadcast on the timeline of the particular follower that was re-transmitted by the particular follower;
identify a total number of broadcasts on the timeline of the particular follower associated with the identified cluster sizes;
calculate a probability that the particular follower will re-transmit a broadcast associated with each of the identified cluster sizes; and
determine an average ratio of the decrease in probability of re-transmissions per unit increase in cluster size associated with a broadcast on the timeline of the particular follower,
wherein the degree of monotony of the particular follower comprises the determined average ratio.

18. The apparatus of claim 11, wherein the program code instructions, when executed by the processor, cause the apparatus to calculate the predicted number of competitor broadcasts during each time slot of the total number of time slots by causing the apparatus to:
identify, based on the received information regarding the producer's followers, a set of competitors; and
calculate a historical average number of broadcasts transmitted by the set of competitors in each time slot of the total number of time slots,
wherein the predicted number of competitor broadcasts during each time slot of the total number of time slots comprises the historical average number of broadcasts transmitted by the set of competitors in each time slot of the total number of time slots.

19. The apparatus of claim 11, wherein the program code instructions, when executed by the processor, cause the apparatus to determine the number of broadcasts for the producer to transmit in each time slot by causing the apparatus to:
generate an objective scoring function based on the discount factors and the predicted number of competitor broadcasts in each time slot; and
identify a number of broadcasts in each time slot of the total number of time slots that maximizes the objective scoring function.

20. The apparatus of claim 19, wherein the program code instructions, when executed by the processor, cause the apparatus to identify the number of broadcasts in each time slot of the total number of time slots that maximizes the objective scoring function by causing the apparatus to:
generate a relaxed scoring function by ignoring an impact of one of the discount factors;
identify a number of broadcasts in each time slot of the total number of time slots that maximizes the relaxed scoring function; and
apply, based on the number of broadcasts in each time slot of the total number of time slots that maximizes the relaxed scoring function, a greedy algorithm to identify the number of broadcasts in each time slot of the total number of time slots that maximizes the objective scoring function.

21. A non-transitory computer readable storage medium for maximizing consumption of broadcasts by a producer, the non-transitory computer readable storage medium storing program code instructions that, when executed by an apparatus, cause the apparatus to:
receive selection of a total number of time slots to use for scheduling broadcasts;
receive information regarding the producer's followers;
identify, based on the received information, discount factors associated with the producer's followers;
calculate, based on the received information, a predicted number of competitor broadcasts during each time slot of the total number of time slots; and
determine, based on the discount factors and the predicted number of competitor broadcasts during each time slot, a number of broadcasts for the producer to transmit in each time slot of the total number of time slots.
